(19) United States
(12) Patent Application Publication
(10) Pub. No.: US 2016/0238410 A1
(43) Pub. Date: Aug. 18, 2016

(54) POSITION SENSOR AND MEASURING ARRANGEMENT

(71) Applicant: ASM Automation Sensorik Messtechnik GmbH, Moosinning (DE)

(72) Inventor: Klaus Manfred Steinich, Zorneding / Poring (DE)

(21) Appl. No.: 14/971,242

(22) Filed: Dec. 16, 2015

(30) Foreign Application Priority Data
Feb. 17, 2015 (DE) 102015102233.8

(51) Int. Cl. G01D 5/14

(52) U.S. Cl. CPC G01D 5/14

(57) ABSTRACT

In order to facilitate mounting, servicing and replacing a sensor arrangement for filling level determination in a tank or a position determination of the piston in an operating cylinder with a magnet field sensing sensor and in order to prevent it from being damaged it is proposed to arrange a rod shaped sensor arrangement on an outside of the magnetizable wall and a magnet interconnection made from plural interconnection magnets or interconnection sections in particular a rotation symmetrical magnet interconnection in an interior of the cylinder or of the tank, thus optionally in the liquid included therein like e.g. hydraulic oil. Through a corresponding selection of the pole orientation of the individual interconnection magnets or interconnection sections the operating field of the magnet interconnection is strong enough so that it penetrates the magnetizable wall and reaches the sensor arrangement.

### I. FIELD OF THE INVENTION

The invention relates to an encoder magnet for a magnetic field sensitive sensor, for example a position sensor, in particular in a cylinder or in a liquid container, in particular in an operating cylinder

### II. BACKGROUND OF THE INVENTION

Magnetic field sensitive sensors react to a magnetic field of an encoder magnet that is moveably arranged relative to the actual sensor wherein the encoding magnet typically is a permanent magnet or includes a permanent magnet, however in some cases the encoder magnet can also be an electro magnet.

Thus, only a portion of the magnetic field generated by the encoder magnet, namely the operating magnetic field put out in an operating direction towards the sensor arrangement is detected, whereas the magnetic scatter field of the encoder magnet that is put out in all other directions, the scatter directions, is not required, but to the contrary depending on orientation and range can even impact the measuring result negatively.

In linear sensors a position or movement of an encoder magnet in a linear direction, for rotation angle sensors in a circumferential direction, is determined relative to a reference position touch free.

In a position sensor of this type the encoder magnet which can be attached e.g. at a moveable machine element causes a generation of a magneto elastic density wave (MEDW) which propagates in a wave conductor arranged in the sensor, e.g. a wire and which is detected by a sensor arrangement at a detection position that is remote therefrom as it is the case typically in magnetostrictive position sensors.

The magnetic field can be determined for example directly by one or plural hall sensors or XMR sensors or indirectly, e.g. by saturating magnetic cores (permanent magnetic linear contactless displacement sensor—PLCD).

A time differential between a generation of the MEDW and its detection at a detection position of the wave conductor that is remote therefrom is used as a measuring variable for determining a position.

A precise function of the position sensor of this type is known quite well so that a detailed description can be omitted.

It is specific for all sensors that are actuated by magnets, in particular permanent magnets and of particular interest for the instant invention that the sensor characteristics are determined to a large extent by a type of the magnetic field of the encoder magnet (=position magnet), this means no only by the maximum field strength and primary orientation of the magnetic field but also by its local shaped and propagation.

Thus, in a position magnet with high field strength for example the distance or the magnetic shielding between the position magnet and the sensor can be greater than for a magnet with lower field strength.

On the other hand side a position magnet whose field strength is locally highly limited can lead to a better location resolution of the sensor.

Depending on a special configuration of the position sensor magnets can be used whose magnetic orientations are oriented parallel to a measuring direction of the sensor (so called axial orientation) or for example also perpendicular to the axis of the sensor (radial orientation).

Numerous proposals have been made to improve the characteristics of position magnets for magnetic position sensors.

U.S. Pat. No. 5,514,961 proposes for example to use an axially oriented ring magnet for a rod shaped sensor wherein the ring magnet envelops the sensor rod and wherein a steel ring is arranged at a face of the ring magnet.

This steel ring is made from a simple magnetizable steel which conducts the magnetic flux lines at one end of the magnetic ring forming a flux conductor.

The magnetic flux lines impact the sensor rod at this location in a concentrated manner and under a steeper angle and lead to a stronger and sharper magnetic pulse which leads to an improved function of the sensor.

However it is a disadvantage of an axial magnet that the propagation of the magnetic field is not independent from the installed position of the magnet and thus properties of the sensor are a function of how the position magnet is oriented. Thus the position magnet is not universally useable.

It is another disadvantage that the magnetic field strength of an axial magnet due to its orientation has a high portion of magnetic flux lines parallel to a sensor rod, which leads to a substantial remote effect when the magnet is oriented incorrectly.

This remote effect of this position magnet can thus degrade sensor properties for example when the position magnet is close to the detection location of the wave conductor.

U.S. Pat. No. 6,271,660 issues another proposal which increases the operating signal of the magnet through a special arrangement.

Therein a position magnet is used, whose magnetic orientation is directed toward the position sensor (radial orientation) and this magnet is combined with two additional magnets which are oriented in the same direction (also radially in parallel to the first magnet but which have an opposite orientation so that a north pole of one magnet is arranged adjacent to a south pole of the other magnets (opposite polar arrangement).

This arrangement facilitates to superimpose the sensor signal of individual magnets in a magnetostrictive sensor so that the extremes of the signal are augmented and thus the steepness a flank angle of the sensor signal is increased. A controlled super position of opposite magnetic fields however is not provided.

This facilitates a greater distance between magnet and sensor. However, this arrangement causes a greater width of the magnet since a width of individual pulses should be almost identical for an optimum superposition.

A distance of individual magnets is determined by the run time of the MEDW in the wave conductor which however respectively requires an adaptation to the particular application.

Additionally a nonmagnetic distance has to be provided between the individual magnets since otherwise the opposite polar magnets would “shorten” magnetically and would cause a reduction of the available field strength.

Additionally the effect of unilateral augmentation of the field strength was used for the first time by (J. C. Mallinson, One-Sided Fluxes A Magnetic Curiosity, JEEE Transactions on Magnets, 9, pages 678-682, 1973).

A combination of magnets with a magnetization arranged offset relative to one another by 90° also known as a Halbach array was used for guiding particle beams (K. Halbach, Nuclear Instruments and Methods, 169, 1 1980).

Later on Halbach arrays were used in particular for generating strong magnetic fields.

Also a use of magnet arrangements in a cylindrical shape or in a spherical shape is known in order to generate significantly increased field strengths in a center of the cylinder or of the sphere.

Encoder magnets in the form of different magnet arrangements are also known from DE 10 2010 010 388.

Typical applications of magnetic field sensitive position sensors are an axial position determination of a piston in an operating cylinder, for example a hydraulic cylinder or a vertical position determination of a float in a tank for a liquid for determining the filling level.

Therein, however, there is a problem in that the electrics of the sensor arrangement that is so far also installed in the interior, thus in the liquid can become defective by a penetrating liquid and the surrounding device, for example the hydraulic cylinder has to be completely disassembled for a checking or replacement of the sensor arrangement, thus of the sensor rod which typically causes a long down time of the respective machine.

### III. DETAILED DESCRIPTION OF THE INVENTION

### a) Technical Task

Thus, it is an object of the invention to provide a position sensor and a measuring arrangement for the described application which prevents the described disadvantages of the prior art.

### b) Solution

The object is achieved by the features of claims 1 and 12. Advantageous embodiments can be derived from the dependent claims.

With respect to the position sensor by itself the object is achieved in that the magnet interconnection used as an encoder magnet includes plural individual interconnected magnets or a one piece interconnected magnet with plural interconnection sections that adjoin each other in the measuring direction or also transversal thereto, in particular in a circumferential direction relative to the measuring direction, wherein there pole orientation is different and which are arranged proximal to each other so that their magnetic fields influence each other.

Radial Orientation

Advantageously the interconnection sections are arranged in the measuring direction of the axial direction of the magnet interconnection behind one another and the pull orientations viewed in measuring direction of all interconnection magnets of the magnet interconnection are oriented radially outward, in particular point symmetrical in particular rotation symmetrical to a center of the interconnection magnets wherein the center is determined in an axial direction.

This causes a resulting magnetic field which is identical in plural or even all radial directions so that it is irrelevant on which side thus offset in which radial direction the sensor arrangement is arranged.

Thus the magnetic interconnection is universally useable and facilitates in particular a subsequent mounting and orientation of the sensor arrangement and the magnetic interconnection significantly.

Through the mutually influencing magnetic fields of the plural interconnection magnets or interconnection sections mutual influencing is achieved in a manner by a carefully selected arrangement of the pole directions of the interconnection magnets or interconnection sections so that a field strength of the magnetic interconnection is increased in the desired operating direction, thus in a radially outward direction. Thus advantageously also the scatter field in the non-used other scatter directions shall be reduced.

Advantageously the magnetic interconnection is made from at least 3, in particular only 3 interconnection magnets or interconnection sections wherein a center interconnection has a center magnetic pull direction which extends from its center the radially outward with respect to the measuring direction. At the face side, thus at the axial face ends of this center composite magnet or interconnection section a respective other interconnection magnet or interconnection section is arranged whose pole direction extends in the axial direction or at the most at an angle of 45° relative to the axial direction and wherein the pull directions of the 2 outer interconnection magnets or interconnection sections are oriented against each other.

This arrangement on the one hand side can generate a very short magnetic interconnection in the axial direction which substantially facilitates placement in a moving or in a moveable component.

In particular this arrangement of the pull directions facilitate an optimum operating field in that the magnetic flux lines extending outward from the center interconnection magnet or interconnection section are compressed by the field lines of the 2 outer interconnection magnets or interconnection sections which are oriented axially against it and thus the magnetic field lines are moved closer to each other over their outward extension so that a very strong operating field is generated from the center of the center interconnection magnet or interconnection section in a radial outward direction and thus advantageously in all radial directions.

Intersected in the measuring direction this yields a torus shaped magnetic field which however when the face side outer interconnection magnets or the interconnection sections are oriented slightly outward with their pull direction which is possible in particular for ring shaped magnets or sections, reaches radially far in outward direction.

Advantageously viewed in axial direction the three interconnection magnets have a round outer contour and advantageously additionally in the center a pass through opening penetrating the interconnection magnet in the axial direction, wherein the pass through opening is advantageously also circular so that an annular configuration of the interconnection magnets is obtained.

Advantageously this annular configuration is the same for all three interconnection magnets from a qualitative and quantitative point of view and also for a magnet interconnection that is made from plural interconnection sections.

Thus, the three interconnection magnets can be mounted very easily on a rod or tube centrally extending through the pass through opening, either with a spacer, in particular an elastic intermediary bearing, in the axial direction between the individual interconnection magnets or also with directly adjacent interconnection magnets.

Tangentially Oriented

Viewed in measuring direction the interconnection sections or interconnection magnets, however, can also be arranged in sequence in a circumferential direction about the measuring direction wherein at least one group of interconnection sections or interconnection magnets is provided in the circumferential direction. A group of this type can cover any subconference angle and also plural such groups can adjoin in the circumferential direction.

In each group the pole direction of the center segment is oriented radially outward and the two adjacent segments respectively have an opposite pole orientation extending in the circumferential direction or tangential to the circumferential direction.

A strong magnetic operating field is thus provided for each such configuration primarily at the circumferential location of the center segment of each group, thus depending on the configuration of the circumference only at one location of the circumference or at few locations of the circumference.

Irrespective of the orientation an attachment of the interconnection magnets at each other can be provided in a form locking manner, thus for example by axial securing against each other or by simple gluing of the composite magnets relative to each other.

On an outside and/or on an inside and/or one or both faces of the magnet interconnection furthermore a sleeve shaped magnetically insulating, insulating element can be arranged which is useful in particular when the magnet interconnection shall also be attached at a soft magnetic component.

Using a position sensor of this type facilitates producing a measuring arrangement in a simple manner, which includes on the one hand side the position sensor described supra, on the other hand side a wall made from soft magnetic material between the sensor arrangement and the encoder magnet arrangement of the position sensor, wherein a liquid can be arranged at one side of this wall, wherein the magnet interconnection is then arranged on the liquid side of the wall, the sensor arrangement can be arranged, at the opposite, typically dry side of the wall which increases the service life of the sensor arrangement and greatly facilitates replacing the sensor arrangement.

Namely the highly concentrated magnetic field of the magnet interconnection wherein the magnetic field is oriented radially outward in all directions can also overcome a wall between the encoder magnet arrangement and the sensor arrangement even when the wall is made from soft magnetic material, like e.g. iron or steel in that the magnetizable wall is initially magnetically saturated and thereafter the magnetic field of the encoder magnet arrangement permeates the wall and still reaches the sensor arrangement.

A single interconnection magnet configured as an encoder magnet would not be able to impart a magnetic field of this strength or at least would require larger dimensions and would be much more expensive to buy. In particular measuring precision would be reduced since even a larger and stronger magnet then does not have a concentrated magnetic operating field.

Advantageously the previously described interconnection magnets or interconnection sections are used which can either be threaded onto the piston rod of the piston or onto a protrusion on an opposite side of the piston that is opposite to the piston rod and extends in an axial direction from the piston, advantageously centrally wherein the protrusion is only used for receiving and attaching the magnet interconnection.

Thus the size, thus length, diameter, material and/or cross section (hollow or solid) of this protrusion can be freely selected according to the requirements of the magnet interconnection to be applied there to since the protrusion does not have to have the same stability as the piston rod.

Thus the protrusion can be simultaneously used as a flux conductor element that is arranged in a center in the interconnection magnets wherein the flux conductor element is made from a soft magnetic material and the annular interconnection magnets can be fixated in a form locking manner in an axial direction by a nut that is threaded onto a free end of the protrusion which has an external thread, wherein the nut is also made from soft magnetic material.

Though the stop, thus for example the bottom side of the piston against which the interconnection magnets are approximated or even pressed is also made from soft magnetic materials at least in portions so that the stop acts as a second face side flux conductor element.

The outer diameter of the annular interconnection magnets and optionally one of the two face side flux conductor elements is thus slightly smaller than an inner diameter of the piston in order to prevent friction relative to the cylinder wall and thus a loss of force.

In order for the protrusion to remain centric either the nut that is threaded on at a free end of the protrusion oriented away from the piston as a circumferential rim of made from sliding material or a separate support ring made from sliding material is slid on which contacts an inside of the cylinder wall and thus centrally supports the protrusion on its entire length and thus provides the desired small distance between the cylinder wall and the interconnection magnets.

By arranging the interconnection magnets and thus the magnet interconnection on a side that is opposite to the piston rod assembly of the magnet interconnection is greatly facilitated on the other hand side this causes a greater length of the enveloping cylinder when the piston shall perform a particular stroke therein.

In order to reduce the additional length of the cylinder as far as possible since the piston often has to have a considerable axial length in order to seal properly the magnetic interconnection can be arranged in a pocket in its entirety or at least partially wherein the pocket is annular an open in an axial direction towards a side that is oriented away from the piston rod in order to minimize the additional length.

Instead of fabricating the piston over the entire cross sectional surface from a soft magnetic material which provides the function as a flux conductor element at a face end of the magnet interconnection the radially outer sealing edge can also be made from a non-magnetizable material thus a desired offset can be provided in radial direction between the protrusion acting as a flux conductor element and the enveloping wall.

The rod shaped sensor arrangement is arranged on an outside of the wall, advantageously using 2 axially offset supports which are rotate able in the circumferential direction about the cylinder so that the sensor arrangement can be positioned at any circumferential location of the cylinder which is a great advantage depending from the assembly situation of the cylinder at surrounding components.

When the rod shaped sensor arrangement additionally penetrates the two supports in axial direction and is moveable therein and fixateable in a particular axial position, for example by a set screw, a zero point of the sensor arrangement can thus be set in a very simple manner.

Depending on an internal configuration of the sensor arrangement it can also be useful to provide the rod shaped sensor arrangement with a circular outer cross section and to be able to rotate it in a corresponding circular pass through opening of the support in order to be able to align the wave conductor of the rod shaped sensor arrangement with respect to its rotational position in an optimum manner relative to the encoder magnet arrangement before fixating, for example with the set screw recited supra.

In an application as a filling level sensor in a tank the magnet interconnection also has to be firmly attached at the float in a vertical direction, the movement direction of the float.

One option is to attach the magnet interconnection irrespective of the configuration of the float at one of its sides and since the float is a hollow element the float will align so that the magnet interconnection attached therein represents the lowest point thus supports the float in a particular position so that a riser tube or a simple thread suffice for vertical guidance.

In order to support the float as close as possible to the wall of the tank the float however typically runs in a surrounding support, either in a riser tube or in a vertical support formed by offset rods or the float is supported vertically moveable at a fixated support rod at which the magnetic interconnection can be attached easily if it has a pass through opening.

In order to facilitate assembly the magnetic interconnection however can also be arranged within the float and is thus not exposed to influences of the surrounding liquid.

This is independent from the float and thus the magnet interconnection being centrally penetrated by the guide rod since then the entire float with the magnet interconnection arranged there on, wherein the magnets are then annular can be arranged in a tight sleeve shaped housing.

It is another option to configure the float large enough in top view so that it covers the entire cross sectional surface of the tank.

This, however, is only helpful for a non circular contour of the tank and thus a non-circular outer contour of the float since only this can prevent a rotation of the float about the vertical axis and the magnet interconnection can be firmly attached at a defined location at the outer circumference of the float so that the magnet interconnection in top view of the tank is always positioned at the same location of the circumference of the tank.

### c) Embodiments

Embodiments of the invention are subsequently described in more detail with reference to drawing figures, wherein:

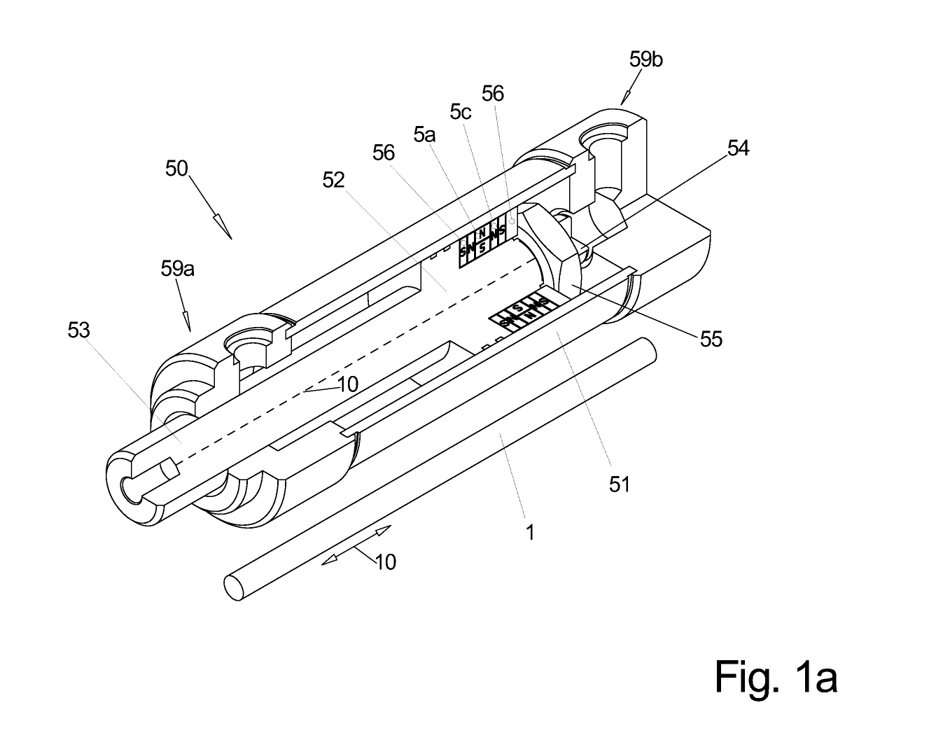

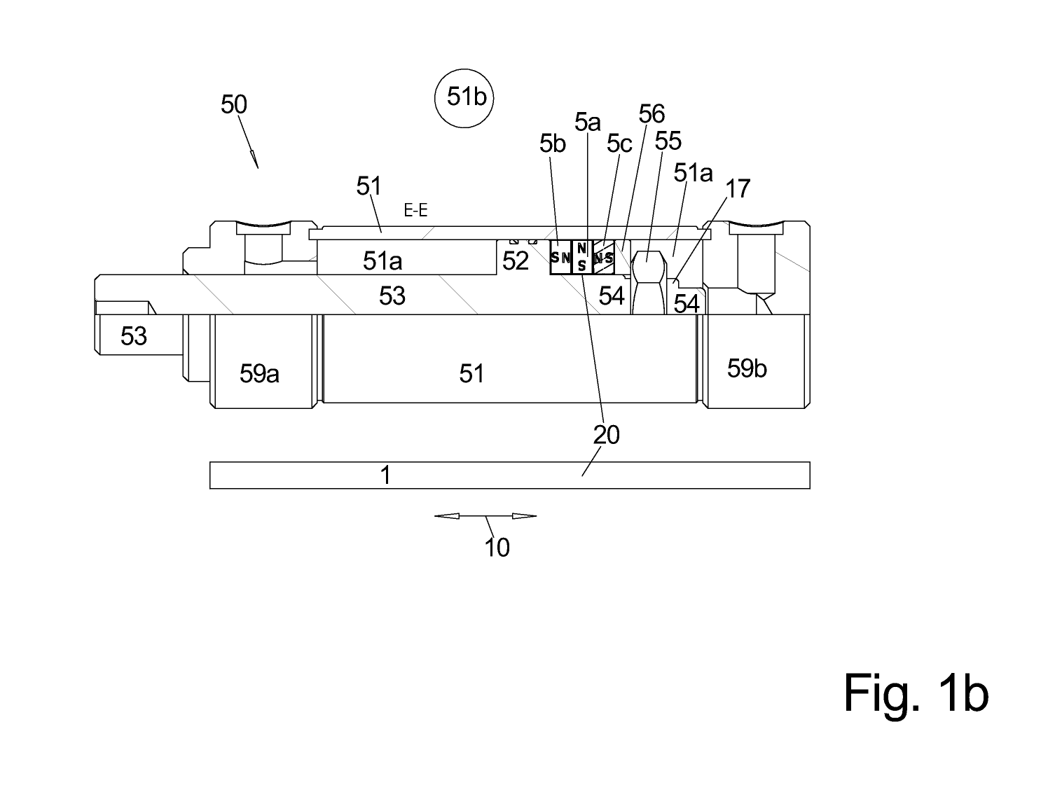

FIG. 1a, b illustrates using the sensor in an operating cylinder;

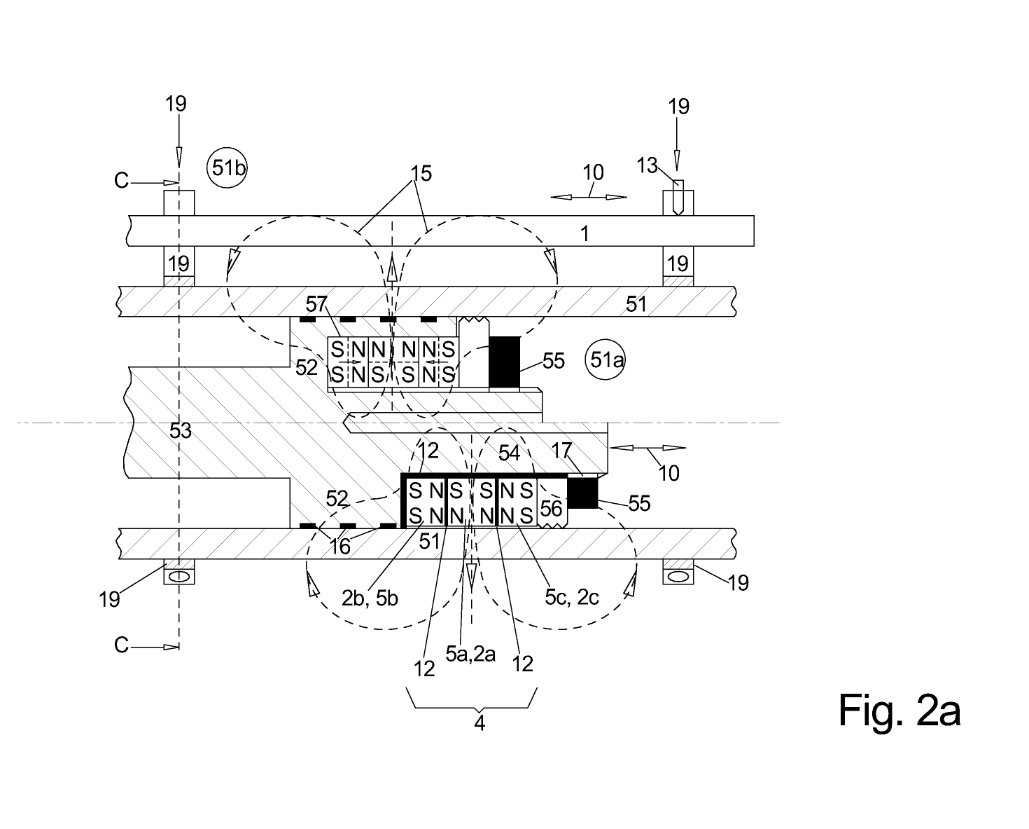

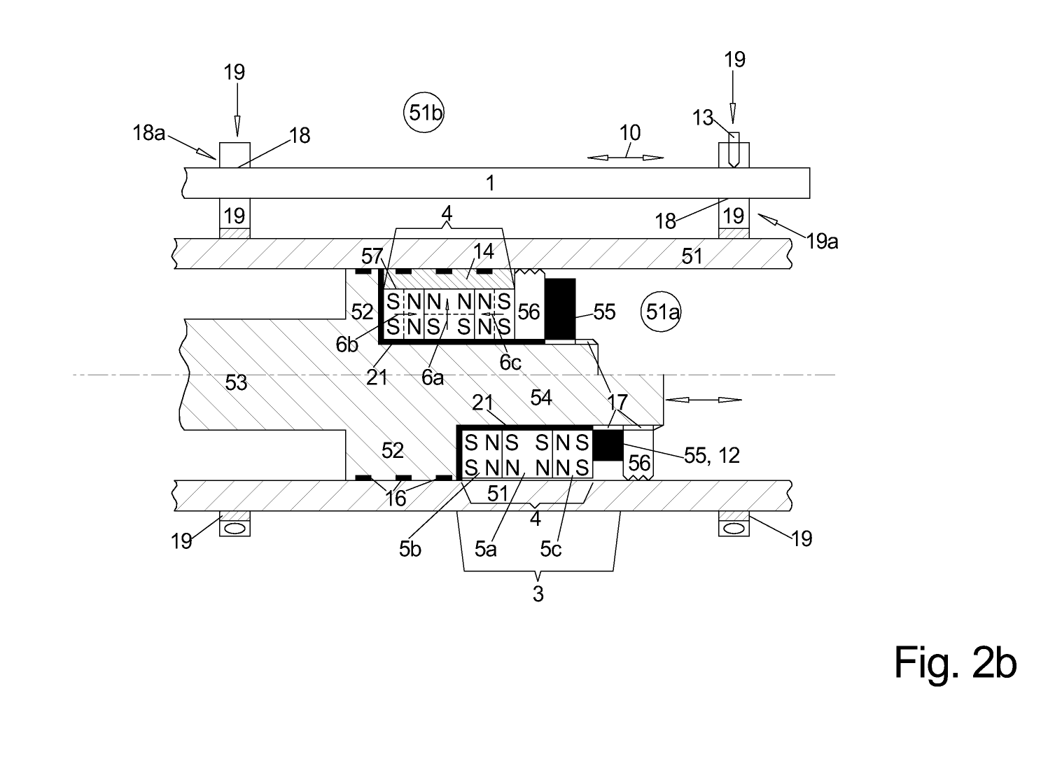

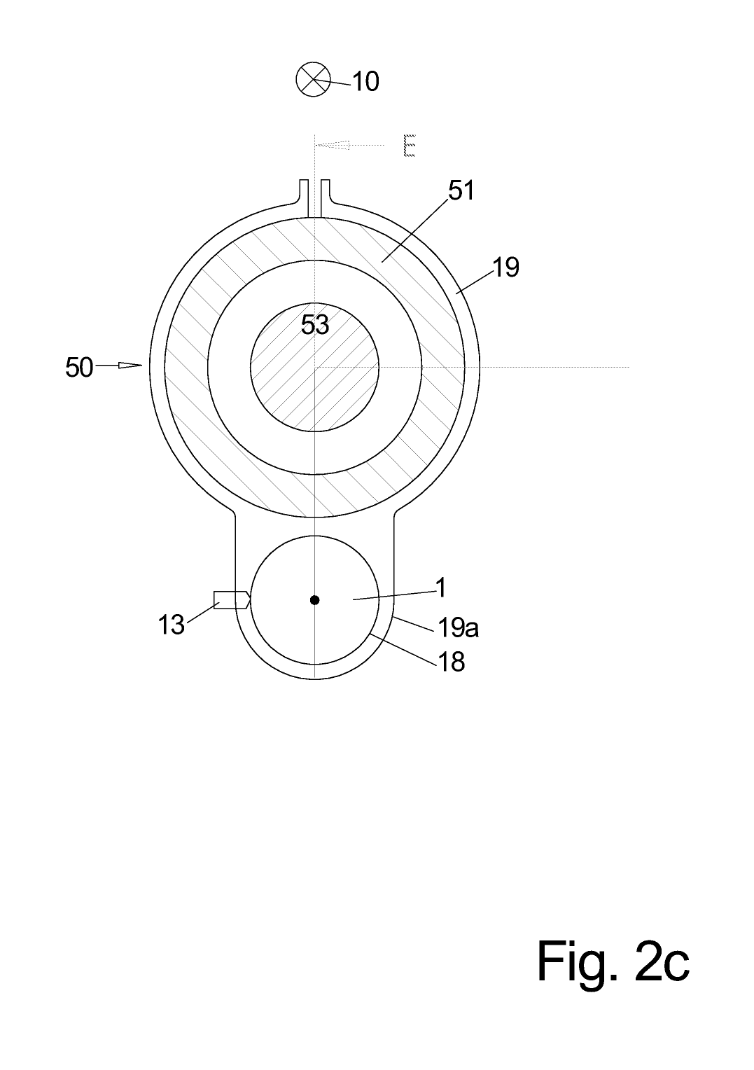

FIG. 2a-c illustrates various mounting variants in a longitudinal sectional view according to FIGS. 1 a-c;

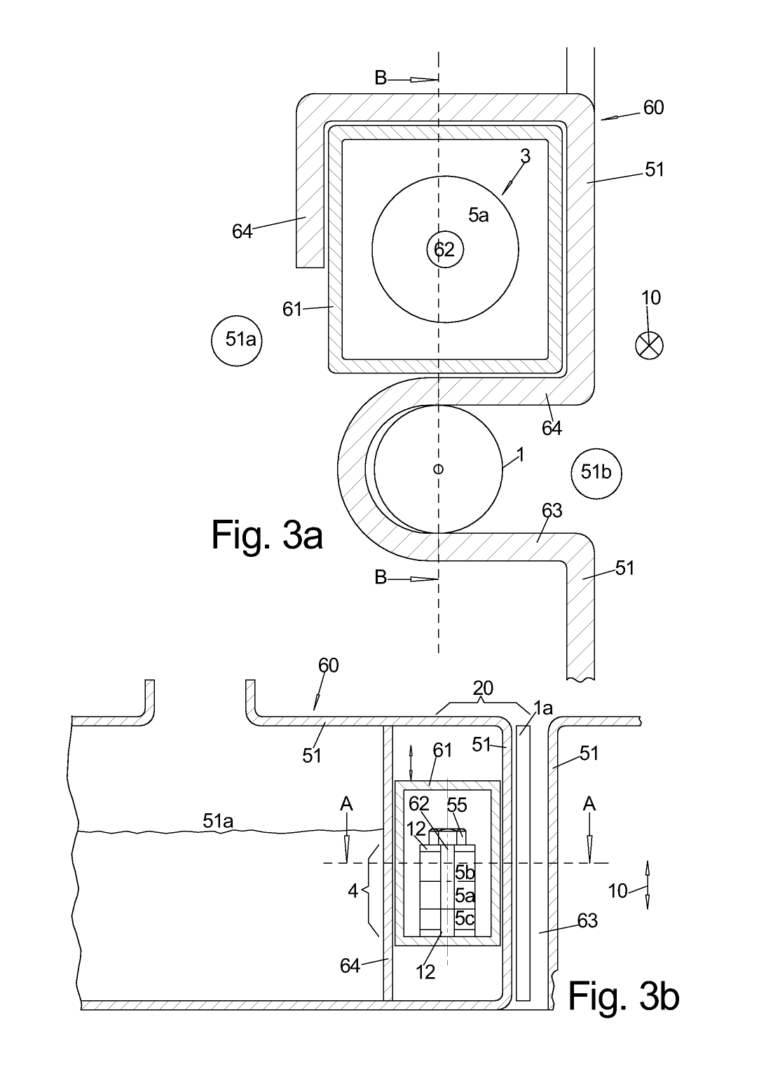

FIG. 3 a, b illustrates a use of the sensor as a filling level sensor in a tank;

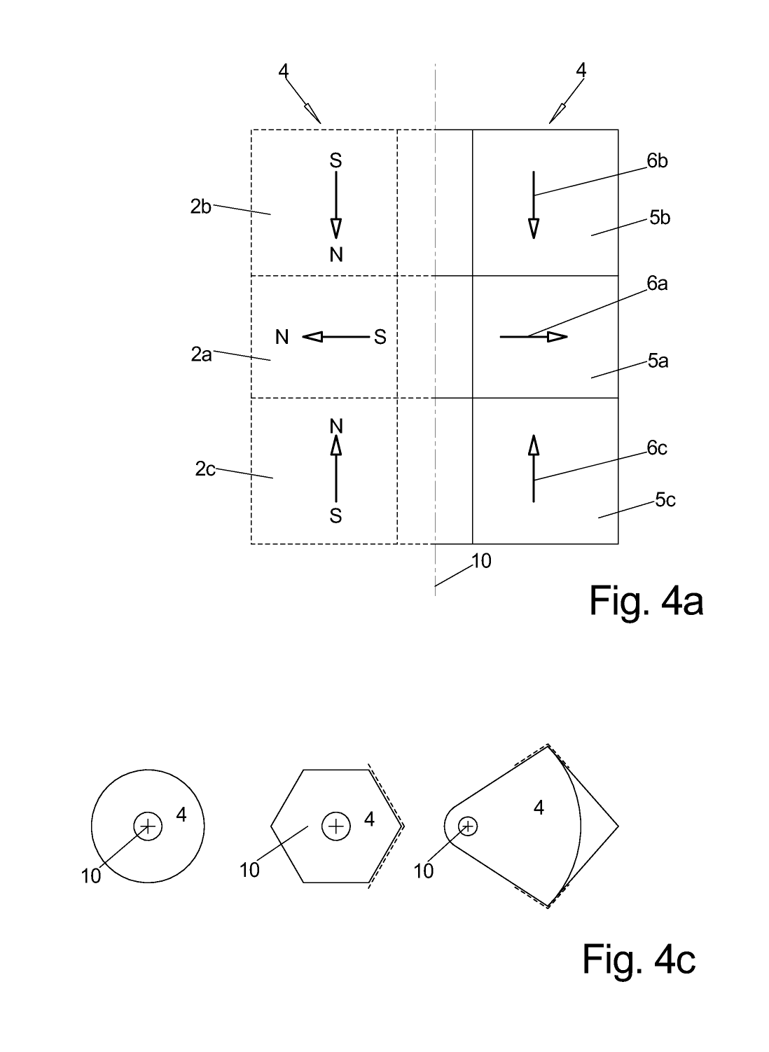

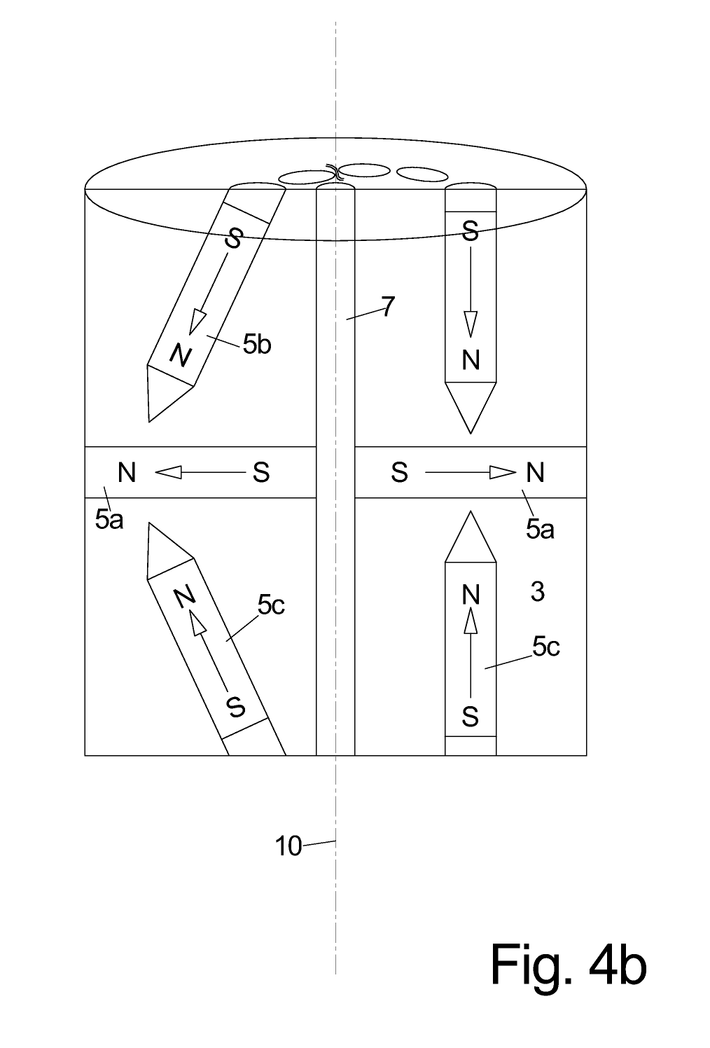

FIG. 4a-c illustrates a variance of the magnet interconnection; and

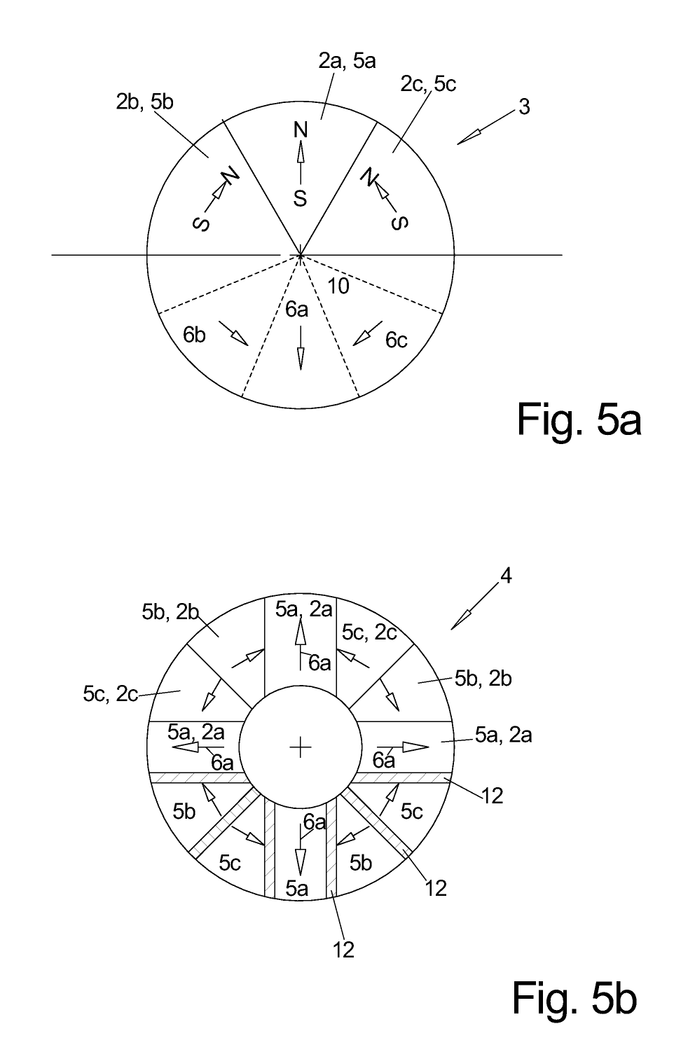

FIG. 5a, b illustrates other variants of the magnet interconnection.

A first embodiment of an operating cylinder unit 50 which is provided with a position sensor 20 according to the invention is illustrated in FIG. 1a in a sectional perspective view, in FIG. 1 b in a partial sectional side view and in FIG. 1c from a side of the protruding piston rod 53 in the axial direction 10 of the measuring direction of the position sensor 20.

The operating cylinder unit 50 is made from the wall 50 of the cylinder, typically a tubular element onto which a head piece is placed tightly closing on a face side and a base element 59b is placed tightly closing on the other side wherein the head piece and the base element at one location of their outer circumferences respectively include a connection for introducing the operating medium into the cylinder 51.

In an interior of the cylinder 51, thus on the liquid side 51a of the wall 51

The piston 52 is arranged tightly sealing at an inside of the cylinder 51 so that it is moveable in the axial direction 10 wherein the piston is connected at its face side with a piston rod 53 which extends in the axial direction 10 through the head piece 59a in outward direction and drives a typically non-illustrated moving element at this location.

Contrary to the described basic shape of an operating cylinder unit 50 in the instant case the piston 52 has an additional protrusion 54 on a side oriented away from the piston rod 53 wherein the protrusion 54 also centrally extends in the axial direction 10 and in the radial annular cavity between the protrusion 54 and the inside of the wall 51 the magnet interconnection 4 is arranged that includes 3 annular axially adjoining interconnection magnets 5b, a, c and an annular support ring 56 on a side of the magnet interconnection 4 which is oriented away from the piston 52.

The protrusion 54 extends axially beyond the magnet interconnection 4 and has an outer thread 17 on its outer circumference onto which a nut 55 is threaded in order to support the magnet interconnection 4 and the support ring 56 in an axially fixated position pressed against a bottom side of the piston 52.

Outside of the operating cylinder unit 50, thus on the dry side 51b of the operating cylinder unit 50 there is a sensor arrangement one which is approximately rod shaped in this case wherein the sensor arrangement 1 also extends in the axial direction 10 which is also the measuring direction of the sensor direction.

It is also evident from FIG. 1b that the base element 59b of the cylinder includes a central recess that is oriented towards the inner cavity, wherein the central recess is large enough to receive the free end of the protrusion 54 which reduces an installed length of the entire cylinder and in particular of the wall 51.

Whereas the sensor arrangement 1 is illustrated in an abstract manner in FIGS. 1 a and 1b, thus unconnected adjacent to the operating cylinder unit 50 to which the sensor arrangement however should advantageously be connected, a suitable support 19 is illustrated in an exemplary manner in a representation of FIG. 1c in the longitudinal direction 10.

This support is made from a ring that is slotted at a circumferential location and which tightly envelops the outer circumference of the wall 51, wherein the ring has outward oriented elbows at a location of the slots in order to be able to clamp the two free ends together in the circumferential direction and thus to be able to clamp the annular support 19 onto the outer circumference of the cylinder 51.

At a circumferential location of the annular support 19, advantageously opposite to the slotted location the annular support 19 has a radially outward extending protrusion 19a which includes an axial pass through opening 18 into which the sensor arrangement 1 fits precisely and can be fixated there in a desired axial position, e.g. by a clamping bolt 13 which extends through the wall of the protrusion 19a.

When the sensor arrangement 1 has a circular outer circumference and the axial pas through opening 18 through the support 19 also has a corresponding circular inner circumference the sensor arrangement 1 can also be brought into the desired rotational position before fixating with the clamping screw 13. This is the case when as illustrated in a cross sectional view in FIG. 2c. The wave conductor wire illustrated in a center of the sensor arrangement 1 is not arranged in the center, but eccentrical, namely then the measuring result can be improved by a proximal positioning of the wave conductor wire at that operating cylinder unit 50.

As illustrated in the longitudinal sectional view of FIGS. 2a and 2b advantageously two supports 19 are provided axially offset from each other in order to fixate the sensor arrangement 1 at least at two axially separate locations.

In FIGS. 2a and 2b plural options for configuring and arranging the magnet interconnection 4 at the piston 52 are illustrated in a longitudinal sectional view through the operating cylinder unit in the portion of the piston 52.

In the solutions in FIG. 2a the protrusion 54 is provided at the piston 52 which protrusion has been recited supra and is arranged opposite to the piston rod 53, wherein an external thread 17 for threading on a nut 55 is provided on an outer circumference of the protrusion 54.

In a lower half of FIG. 2a an attachment solution is illustrated that corresponds to FIGS. 1a-c and which is advantageously configured rotation symmetrical about an axial direction, the measuring direction 10.

Thus, the piston 52 has a relative large axial extension which is required to arrange plural piston rings 16 axially offset therein.

Axially adjacent to the piston 52 along the protrusion 54 three annular interconnection magnets 5a, b, c or interconnection sections 2a,b,c are arranged on the protrusion 54 which extends through the central pass through opening 7.

Adjacent to a free end of the piston rod 54 an annular support ring 56 is inserted onto the protrusion 54. Using a nut 55 that is threaded onto an external thread 17 of the protrusion 54 the support ring 56 and the magnet interconnection 4 made from the three interconnection magnets 5a,b,c, is pressed axially against the back side of the piston 52 oriented away from the piston rod 53 and secured in this position.

Typically the piston 52 and the protrusion 54 are made from the same typically soft magnetic material and are advantageously produced integral in one piece and thus the nut 55 is made from a soft magnetic material like e.g. steel.

Then the piston 52, the protrusion 54 and also the nut 55 act as flux conductors to bundle the field lines in the intended manner, so that a strong oriented magnetic field is generated which is oriented in radially outward direction.

In case the flux conductor element effect of the enveloping iron or steel elements shall be avoided a magnetically insulating material would have to be arranged between the materials and the magnetic interconnection 4 which however is not available in the required layer density but could only be achieved in principle by a sequence of materials with different coercive field strengths.

In the present case however an elastic intermediary layer 12 is on the radial inside and on a face of the magnet interconnection 4 that is oriented towards the piston 52 whereas the support ring 56 can be made from a respective material on the opposite face side in order to prevent damaging the interconnection magnets when they are pressed against each other in an axial direction.

Thus the interconnection magnets 5a, b, c have an outer circumference which is smaller than the inner circumference of the cylinder 51 so that the two do not contact this inside when the piston 52 is moved.

FIG. 2a illustrates a solution in the upper half in which a face of the piston 52 that is oriented away from the piston rod 53 includes an annular pocket 57 into which the annular interconnection magnets 5a, b, c or the one piece magnet interconnection 4 fit with its various interconnection sections.

The support ring 56, however, has a larger outer circumference and slides at the inside of the wall 51 in order to support the protrusion 54 also in this portion centrally in the cylinder 51 wherein at least the outside of the support ring 56, advantageously the entire support ring 56 is made from an easily sliding material like e.g. plastic. The support ring is typically made from a non-magnetizable material.

Since the magnet interconnection 4 is advantageously received axially completely in the pocket 57 no support ring 56 is required contrary to the solution in the lower half of FIG. 2a but the nut 55 can be applied directly to the last interconnection magnet 5c which reduces the entire length of the arrangement.

When the pocket 57 is configured axially deep enough so that it can receive the entire magnet interconnection 4 the piston 52 is advantageously configured with piston rings 16 over an entire axial extension of its outer circumference which improves sealing the piston 52 relative to the wall 51.

The radial annular portion of the piston 52 which envelops the magnet interconnection 4 can be made from the same material as the piston 52 and then can be advantageously configured integral therewith and is then typically made from a soft magnetic material, e.g. steel. This has the disadvantage that the radial thickness of the piston 52 has to be penetrated by the magnetic fields of the magnet interconnection 4 in addition to the wall 51.

In order to prevent this the solution according to FIG. 2 b upper half can be selected.

FIG. 2b illustrates an arrangement which corresponds to an arrangement in the upper half of FIG. 2a which however differs in that a sliding sleeve 14 is provided which radially envelops the magnet arrangement 4 on an outside between the interconnection magnets 5a, b, c and the inner circumference of the wall 51 which is advantageously made from non-magnetizable material like e.g. plastic and thus not configured integral in one piece together with the piston 52 but which can still support piston rings at its outside.

The piston 52 then advantageously has a flat bottom side radially outside of the protrusion 54 and the sliding sleeve 14 has a length which is identical with or slightly greater than the length of the magnet interconnection 4. Using the advantageously also provided nut 55 the sliding sleeve 14 can be axially pressed against the bottom side of the piston 52 in a tight manner using the threaded on nut 55 with or without the illustrated support ring 56 placed between the nut 55 and the sliding sleeve 14.

The solution has the advantage that a sufficiently large axial seal length is maintained but radially from an inside towards the outside the magnetic field 15 whose field lines are illustrated in an exemplary manner at one location in FIG. 2a does not have to penetrate additional magnetizable material beside the wall 51.

Advantageously also in this solution an elastic intermediary layer 12 is arranged on an inside of the magnet interconnection 4 and/or on one or both face sides.

This causes a dead zone in which the position is not measurable. Thus on the opposite side of the piston 52, in particular however it makes exchanging the magnet interconnection 4 more difficult in case it has to be exchanged since the freely terminating protrusion 54 is accessible more easily if required, then the piston rod 53 which is coupled with another element at its end arranged opposite to the piston 52.

All magnet interconnections 4 illustrated in the figures are arranged rotation symmetrical about the direction 10, the measuring direction.

In the lower half of FIG. 2b differently from the illustration in the lower half of FIG. 2a the nut 55 acting as a fluid conducting element is arranged directly axially adjacent to the magnet interconnection 4 and presses the interconnection magnets 5a, b, c, thus without the elastic intermediary layer 12 axially against the piston 52, whereas the support ring 56 e.g. made from plastic material adjoins in a direction towards a free end of the protrusion 54, for example in that the support ring 56 itself at its inner circumference includes an inner thread which fits onto an outer thread 17 of the protrusion 54 and can be threaded thereon.

This solution has the advantage that at both faces directly or indirectly through an elastic intermediary layer 12 arranged there between flux conductor elements are arranged that contact the magnet interconnection 4 on one side in the form of the piston 52 and the protrusion 54 on the other side in the form of the nut 55.

In all cases the protrusion 54 can also be bored hollow from the free end so that it has a sleeve shape in the portion of the magnet interconnection 4 which additionally favors its effect as a flux conductor element.

It is appreciated that all embodiment that are illustrated in FIGS. 2a and 2b and other possible embodiments of a magnet interconnection 4 can be configured
rotation symmetrical about the measuring direction 10 and/or
can also be arranged opposite to each other on the piston rod 53 instead of being arranged on the protrusion 54.

FIG. 3b illustrates an arrangement of the position sensor 20 including the sensor arrangement 1 and the magnet interconnection 4 at a tank 60 in a vertical sectional view and in FIG. 3a in a top view from above.

Thus, the magnet interconnection 4 is arranged in an interior of the hollow float 61 that moves vertically with the fluid level, wherein the hollow float 61 certainly has to have a sufficient free volume in addition to the magnet interconnection 4 in order to have buoyancy in the liquid stored in the tank 60.

The magnet interconnection 4, however, can also be arranged outside the float 61 but fixated to the float 61.

It is only relevant that the magnet interconnection 4 is always at the same place of the float 61 in top view, transversal to the movement direction of the float 61, the axial direction 10 which is simultaneously the measuring direction 10 of the sensor arrangement 1 and when the magnet interconnection 4 is arranged eccentrical relative to the float 61 in top view, the float 61 cannot rotate about the vertical direction. Thus when computing the true filling level the elevation difference between the center of the magnet interconnection 4 in the vertical direction and the submersion volume of the float have to be considered.

The figures illustrate an embodiment in which the float 61 is made from a hollow cuboid wherein the encoder magnet arrangement 3 is fixated in an interior of the cuboid.

The cuboid float 61 in top view of FIG. 3a is always supported at the same location within the tank 60 in which it is supported by respective vertically extending supports in transversal directions relative to vertical.

In this case the float 61 is arranged in one corner of the wall 51 of the tank 60 and supported at 2 additional rectangle sides of the horizontal cross section of the float 61 in that a support wall 64 protrudes inward from the outer wall on one side and also on the other side of the corner a support wall 64 of this type protrudes inward from the outer wall 51.

One of the two support walls 64 thus forms a portion of an inward oriented bulge 63 of the outer wall 51 viewed in top view, wherein the bulge extends substantially over the entire height of the tank as evident best from FIG. 3b.

The indentation 63 is configured with respect to its width so that the sensor rod 1a of the sensor arrangement 1 can be firmly positioned extending over the height of the tank 60 so that it is arranged protected.

Certainly the sensor rod 1 can also be arranged at a straight extending outer wall 51 at any location of the outside, thus on a dry side 51b of the tank 60 as illustrated in FIG. 3a alternatively with dashed lines.

Depending on where the sensor rod 1a is arranged the magnet interconnection 4 viewed in top view is arranged at a location in top view in the tank 60 and positioned in this illustrated case within the float 61 so that the location is as close as possible to the sensor rod 1a. However care must be taken that a distance of the magnet interconnection 4 from the surrounding soft magnetic materials, for example the walls of the support channel formed by the sheet metal of the tank are radially offset by the same amount in all directions in order to prevent a magnetic adherence at one side of the support channel which would prevent a free movement in the measuring direction 10.

When the sensor rod 1a is arranged in the bulge 63 the magnet interconnection 4 is arranged as closely as possible at a side of the float 61 that is arranged oriented towards the sensor rod 1a and also in the transversal direction as close as possible to the sensor rod 1a.

In the instant embodiment the float 61 is configured rectangular and the interconnection magnets 5a, b, c, have an annular shape in top view, wherein the outer circumference of the interconnection magnets 5 a, b, c is much smaller than the inner diameter of the float 61 which is typically necessary so that the float 61 still has sufficient buoyancy.

The interconnection magnets 5 a, b, c, are thus slid onto a support rod 62 vertically extending from the base of the float at a defined position and a nut 55 is threaded for fixation purposes onto an upward protruding end of the support rod 62 which has an external thread.

Since the float 61 is typically made from non-magnetizable material like e.g. plastic material a support plate made from soft magnetic material is slid onto the support rod 62 first wherein the support plate is thus arranged under the lowest interconnection magnet 5c and advantageously has approximately a shape and external dimensions of the nut 55 which is advantageously also made from a soft magnetic material and acts as a flux conductor element at an upper end. In case the nut 55 is made from non-magnetizable material like e.g. plastic material a support plate of this type is also applied to the upper most interconnection magnet 5b before the nut 55 is threaded on as illustrated in FIG. 3.

Additionally a sleeve from soft magnetic material can be provided as a radially inner flux conductor element between the support rod 62 and the interconnection magnets 5a, b, c.

This way the magnet interconnection 4 is arranged in top view at a particular location of the plan form of the float 61 and the float 61 cannot rotate in its support either in top view.

If, however, the float 61 is configured circular and could rotate in its vertical support the magnet interconnection 4 is advantageously arranged centrally in the plan form of the float 61 and advantageously so that it completely fills the cross section of the float 61.

FIGS. 4a, b illustrate a magnet interconnection 4 in which the individual interconnection magnets or interconnection sections are arranged in axial sequence in the measuring direction 10, whereas FIGS. 5a, b illustrated solutions in which the individual interconnection magnets or interconnection sections are arranged in a direction transversal to the measuring direction, in particular in a circumferential direction about the measuring direction.

FIG. 4a illustrates an axial section view through an annular magnet interconnection 4 which is illustrated in the left half of the figure as a one piece magnet interconnection 4 with interconnection sections 2a-c, in the right figured half however it is configured from individual interconnection magnets 5a, b, c, which touch even at their face sides.

Independently therefrom the pole orientation 6a of the center interconnection magnet 5a, or interconnection section 2a is oriented radially outward, as the lateral interconnection magnets 5b, 5c or interconnection sections 2b, 2c contacting on both face sides, thus in the axial direction 10 respectively have a pole orientation 6b, 6c extending in the measuring direction 10, wherein the two pole orientations are oriented against each other.

FIG. 4c viewed in measuring direction 10 illustrates that the outer contour of a magnet interconnection 4 according to the left illustration can be a circular outer contour according to the center illustration however also a polygon shaped thus hexagonal outer contour. The latter has the advantage that the non circular outer contour prevents a rotation of the magnet interconnection 4 about the longitudinal axis 10 by a respective application of a support element from an outside to one or plural outer surfaces which is necessary in particular when the pole orientations are not configured rotation symmetrical but only radiate a strong magnetic operating field in one or individual radial directions.

Thus for example FIG. 4c illustrates a magnet interconnection 4 of this type which only represents a segment about the measuring direction 10 and therefore provides the option e.g. at the flanks or at the corners for this viewing direction in order to prevent a rotation of the segmented magnet interconnection 4 about the measuring direction 10.

Thus, FIG. 4b also illustrates a longitudinal sectional view of a cylindrical magnet interconnection 4 also with a central pass through 7 so that the individual interconnection magnets 5a, b, c do not have to be configured annular disc shaped but can be inserted in a simple manner, e.g. as rod magnets 5a, b, c into respective recesses of a base element 3 which can be made for example from a plastic material or another non-magnetizable material which renders production more economical.

Thus, the center interconnection magnet 5a is simply inserted into a radially extending recess that is open towards the enveloping surface and configured accordingly, as required in circumferential direction in even angular offsets.

The interconnection magnets 5a, b, c arranged in the measuring direction 10 on both sides therefrom are respectively inserted into accordingly configured recesses that are open towards the face side and extend in an axial direction wherein the recesses extend in the right image half in the measuring direction 10, in the left image half however at a slant angle relative thereto and which are oriented radially outward at a slant angle from the face side opening in the base element 3.

Also these recesses and interconnection magnets 5b, 5c can be advantageously arranged in multiples in the circumferential direction depending on the number of circumferential locations where the operating field is required.

The individual interconnection magnets 5a, b can be configured for example as simple rod magnets with any cross section, advantageously a circular or rectangular cross section.

For FIGS. 4 a-c it holds furthermore that the cross sectional shape of the central pass through opening which is used primarily for attachment at a surrounding component is also irrelevant for the invention however the cross section is typically selected circular for reasons of simplicity.

FIG. 5a looking in measuring direction 10 illustrates a magnet interconnection 4 which is made from three triplet groups of interconnection magnets 5a, b, c, or interconnection sections 2a, b, c which adjoin in the circumferential direction. Each triplet group extends in this case over 180° of the circumference so that two such triplet groups yield a complete circumference of 360° which however is not important for the invention with respect to the angular extension of one group nor the number of groups but depends from the respective application.

For each group the pole direction 6a of the center segment of the group is oriented in radially outward direction and the pole directions 6b, c of the segments arranged adjacent thereto, thus the interconnection magnets 5b, c or interconnection sections 2b, c are oriented in a circumferential direction or tangential to a circumferential direction of a respective segment, however respectively against the center segment 6a.

In FIG. 5a the interconnection magnet does not have any center pass through 7 which is also possible for all other configurations of a magnet interconnection 4.

FIG. 5b illustrates viewed in measuring direction 10 in turn again a circular annular magnet interconnection with a central also circular pass through 7, however, like in FIG. 5a with triplet groups of interconnection magnet or interconnection sections adjoining each other in the circumferential direction.

In this case however these are four such triplet groups so that there is one respective radially outward oriented pole orientation that is offset by 90°.

In FIG. 5b the respective center interconnections 2a or interconnection magnets 5a have a constant width in the viewing direction, whereas the others respectively have an approximately circular segment shaped configuration which becomes wider in a radial outward direction.

In the lower half of FIG. 5b furthermore elastic intermediary layers 12 are arranged between the individual segments in order not to damage the interconnection magnets 5a, b, c that are individual interconnection magnets in this case.

### REFERENCE NUMERALS AND DESIGNATIONS

1 sensor arrangement
2a-c interconnection section
3 base element
4 magnet interconnection
5a, b, c interconnection magnet
5′ outer contour
6a, b, c pole orientation
7 pass through opening
8 field line
9 contact surface
10 axial direction
11 transversal plane
12 sliding sleeve
13 set screw
14 sliding sleeve
15 field line
16 piston ring
17 external thread
18 axial pass through opening
19 support
19a protrusion
20 position sensor
21 magnetic insulating element
50 operating cylinder unit
51 cylinder wall
51a liquid side
51b dry side
52 piston
53 piston rod
54 protrusion
55 nut
56 support ring
57 pocket
58 rim
59a head element
59b base element
60 tank
61 float
62 support rod
63 indentation
64 support wall

1. A magnetic field sensitive position sensor (20) that measures in a measuring direction (10), the position sensor (20) comprising:
a sensor arrangement (1) which extends in the measuring direction (10); and
a magnet interconnection (4) that is moveable in the measuring direction (10) relative to the sensor arrangement (1) wherein a position of the magnet interconnection (4) in the measuring direction (10) is detectable by the sensor arrangement (1),
wherein the magnet interconnection (4) is either integrally configured with plural interconnection sections (2a, b, c) or configured in plural elements with plural interconnection magnets (5a, b, c),
pole orientations (6a, b) of the interconnection sections (2a, b, c) or interconnection magnets (5a, b, c) are different, and;
the interconnection magnets (5a, b, c) or the interconnection sections (2a, b, c) are arranged at a distance from each other, so that they contact each other so that their magnetic fields overlap.

2. The position sensor (20) according to claim 1,
characterized in that
the interconnection sections (2a, b, c) are arranged behind each other in the measuring direction (10), the axial direction (10), and the pole orientations (6a, b, c) viewed in the measuring direction (10) of all interconnection magnets (5a, b, c) of the magnet interconnection (4) are oriented radially outward, point symmetrical, in particular rotation symmetrical to a center of the interconnection magnets (2a, b) viewed in the axial direction.

3. The position sensor (20) according to claim 1,
characterized in that
the magnet interconnection (4) includes three interconnection magnets (5a-c) or interconnection sections (2a, b, c) wherein a center interconnection section has a pole orientation (6a) from its center radially outward with respect to the axial direction (10) and a respective additional interconnection magnet (5b, c) or interconnection section is provided on a face side of the axial direction (10) on both sides at the center interconnection magnet (5a) or the interconnection section (2a), wherein a pole orientation (6b,c) of the interconnection magnet or interconnection section extends in the axial direction or at the most at an angle of 45° relative to the axial direction (10), wherein the pole orientations of the two outer interconnection magnets (5b, c) or interconnection sections (2b, c) are oriented against each other.

4. The position sensor (20) according to claim 1,
characterized in that
viewed in the axial direction (10) the three interconnection magnets (5a, b, c) or interconnection sections (2a, b, c) have a circular outer contour (5) and in particular have an advantageously circular pass through opening (7) in a center and are thus configured annular.

5. The position sensor (20) according to claim 1,
characterized in that
for annular interconnection magnets (2a, b, c) a diameter of the central pass through opening (7) is sized identical for all interconnection magnets (2a, b) of the magnet interconnection (4).

6. The position sensor (20) according to claim 1,
characterized in that
the interconnection magnets (2a, b, c) are arranged in respective recesses of a base element (3), inserted therein.

7. A position sensor (20) according to claim 1,
characterized in that
the interconnection magnets (5a, b, c) are glued together at a face side or joined in a form locking manner.

8. A position sensor (20) according to claim 1,
characterized in that
viewed in the measuring direction (10) the interconnection sections (2a, b, c) or the magnets (5a, b, c) are sequentially arranged as segments in the circumferential direction about the measuring direction (10) wherein one respective segment has a radially outward oriented pole orientation (6a) and the two adjacent segments have a pole orientation (6b, c) oriented in the circumferential direction or tangential to the circumferential direction, wherein the pole orientations of the two adjacent segments are oriented opposite to each other and towards the center segment.

9. A position sensor (20) according to claim 1,
characterized in that
elastic intermediary layers (12) are arranged between the segments.

10. A position sensor (20) according to claim 1,
characterized in that
sleeve shaped magnetically insulating insulation element (21) is arranged on an outside, inside and/or face side of the magnet interconnection.

11. A position sensor (20) according to claim 1,
characterized in that
plate shaped, elastic intermediary layers (12), made from non magnetizable plastic material, are arranged between the interconnection magnets (2a, b, c) of the magnet interconnection (4) in the transversal plane (11) relative to the axial direction (10).

12. A measuring arrangement comprising:
a position sensor (20) according to claim 1;
a wall (51) made from soft magnetic material between the sensor arrangement (1) and the magnet interconnection (4), wherein a liquid is arranged on a liquid side (51a) of the wall (51),
characterized in that the magnet interconnection (4) is arranged on the liquid side (51a) of the wall (51) and the sensor arrangement (1) is arranged on an opposite dry side (51b) of the wall (51).

13. The measuring arrangement according to claim 12,
characterized in that
the wall (51) is a cylinder of an operating cylinder unit (50).

14. The measuring arrangement according to claim 12, characterized in that a piston (52) of the operating cylinder unit (50) is axially fixated at the magnet interconnection (4) in the operating cylinder unit (50)

15. The measuring arrangement according to claim 12, characterized in that the annular interconnection magnets (5a, b, c) are axially penetrated by the piston rod (53) or on a side oriented away from the piston rod (53) penetrated by an axial extension (54) of the piston (52).

16. The measuring arrangement according to claim 12, characterized in that the piston (52) and/or the piston rod (53) and/or the protrusion (54) are made from a soft magnetic material and a magnetic insulating element (21) is arranged between the magnet interconnection (4) and the soft magnetic material.

17. The measuring arrangement according to claim 12, characterized in that the outer contour (5) of the magnet interconnection (4), particular of the interconnection magnets (5a, b, c) is slightly smaller than an outer circumference of the piston (52) so that the interconnection magnets (5a, b, c) do not contact an inside of the cylinder (51) at their outer enveloping surface.

18. The measuring arrangement according to claim 12, characterized in that the encoder magnet arrangement (3) is arranged in an axially open pocket (57) of the piston (52), wherein the piston (52) is made from a non-magnetizable material.

19. The measuring arrangement according to claim 12, characterized in that the sensor arrangement (1) is arranged at an outer circumference of the cylinder (51) using at least two axially offset supports (19) respectively including an axial pass through opening (18) into which the sensor arrangement (1) fits and can be fixated therein, in particular by a clamping bolt.

20. The measuring arrangement according to claim 12, characterized in that the sensor arrangement (1) can be positioned and fixated in the pass through opening (18) axially and also with respect to its rotation position and includes a circular outer circumference and the pass through opening (18) has a circular inner contour with a fitting size.

21. The measuring arrangement according to claim 12, characterized in that the wall (51) is a wall of a tank (60) for a liquid in which a float (61) to which the magnet interconnection (4) is firmly connected floats on a surface of the liquid and the sensor arrangement (1) is arranged in a vertical direction on an outside of the tank (60).

22. The measuring arrangement according to claim 12, characterized in that the magnet interconnection (4) is arranged in a float (61) so that the magnet interconnection (4) is only rotatable about a vertical axis and the float (61) extends in the vertical direction in a support.

23. The measuring arrangement according to claim 12, characterized in that the sensor arrangement (1) is arranged in a concave bulge (63) in an outside of the tank (60).
